(19) United States
(12) Patent Application Publication
(10) Pub. No.: US 2026/0091319 A1
(43) Pub. Date: Apr. 2, 2026

(54) CAR TO CONSOLE GAME PLAY

(71) Applicant: Sony Interactive Entertainment Inc., Tokyo (JP)

(72) Inventor: Doron Griss, San Mateo, CA (US)

(21) Appl. No.: 18/905,102

(22) Filed: Oct. 2, 2024

(51) Int. Cl. A63F 13/655; A63F 13/335; A63F 13/69

(52) U.S. Cl. CPC A63F 13/655; A63F 13/335; A63F 13/69

(57) ABSTRACT

Techniques are provided for tying vehicle computer game play to at-home game experiences by using travel data and captured images/web-based knowledge to generate similar environments for the at-home game. Vehicle data and routes can be used to map an environment which is imported into an at-home game using machine learning. Additionally, the home console experience can be expanded by knowing where home is and creating challenges, collectibles, and unlocking levels based on in-vehicle play.

### FIELD

The present application relates generally to tying play of computer simulations such as computer games in vehicles such as car to play at computer simulation consoles.

### BACKGROUND

Play of computer simulations such as computer games is moving beyond TV. As envisioned herein, computer games may be played by non-driving passengers in vehicles.

### SUMMARY

As further envisioned herein, tying game play in vehicles to game play on a console with a TV displaying the game increases user engagement and enjoyment. Specifically, by tying vehicle game play to at-home experiences using travel data and captured images/web-based knowledge to generate similar environments for game, gamer engagement and enjoyment is increased. Collectibles and achievements from vehicle play can be transferred to home consoles for visualizing.

Accordingly, an apparatus includes at least one processor system configured to identify route information related to a user during play of a game during travel of the user along a route, and modify a computer simulation for play of the computer simulation at a residence related to the user based at least in part on the route information.

In some examples the computer simulation comprises a computer game.

In example implementations the processor system can be configured to identify engine control module (ECM) information generated during the travel of the user along the route, and modify the computer simulation based at least in part on the ECM information. In addition or alternatively, the processor system may be configured to identify one or more images generated by a camera during the travel of the user along the route, and modify the computer simulation based at least in part on the one or more images. In addition or alternatively, the processor system may be configured to identify one or more images related to the route from an Internet source, and modify the computer simulation based at least in part on the one or more images related to the route from an Internet source.

In addition to the above, in some examples the processor system can be configured to present, in a computer game being played by a user as the user travels along the route, at least one challenge, and responsive to the user meeting the challenge, unlock a collectible and/or level in the computer simulation during play of the computer simulation at a residence related to the user.

In another aspect, a device includes computer memory that is not a transitory signal and that in turn includes instructions executable by at least one processor system to present, in a computer game being played by a user as the user travels along a route, at least one challenge. The instructions are executable to, responsive to the user meeting the challenge, unlock a collectible and/or level in a computer simulation during play of the computer simulation at a residence related to the user.

In another aspect, a method includes presenting a computer simulation on a display in a vehicle as the vehicle travels along a route. The method also includes tying play of the computer simulation in the vehicle to at-home game experiences by using travel data and/or captured images during travel and/or web-based knowledge to generate similar environments for an at-home game.

If desired, the method may include using vehicle data and routes to map an environment which is imported into an at-home game using machine learning. In some embodiments the method can include expanding the home console experience by knowing where home is and creating challenges, collectibles, and unlocking levels based on in-vehicle play.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates a vehicle game play environment;

FIG. 3 illustrates a block diagram of a machine learning (ML) model-based system for modifying computer simulations such as computer games for home play based on prior vehicle play;

FIG. 4 illustrates example logic in example flow chart format for training the ML model in FIG. 3;

FIG. 5 illustrates example logic in example flow chart format for using the ML model in FIG. 3;

FIG. 6 illustrates an example screen shot of an example user interface (UI) that can be presented during vehicle play;

FIG. 7 illustrates an example screen shot of an example UI that can be presented during home play subsequent to vehicle play;

FIG. 8 illustrates an example screen shot of an example UI of a computer simulation in home play modified according to vehicle play;

FIG. 9 illustrates example logic in example flow chart format for creating challenges for vehicle play to enable a gamer to earn collectibles and unlock levels for importation to home play;

FIG. 10 illustrates an example screen shot of an example UI of a computer simulation during vehicle play presenting a challenge to unlock a collectible; and

FIG. 11 illustrates an example screen shot of an example UI of a computer simulation during home play presenting an opportunity to use a collectible from vehicle play during home play.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

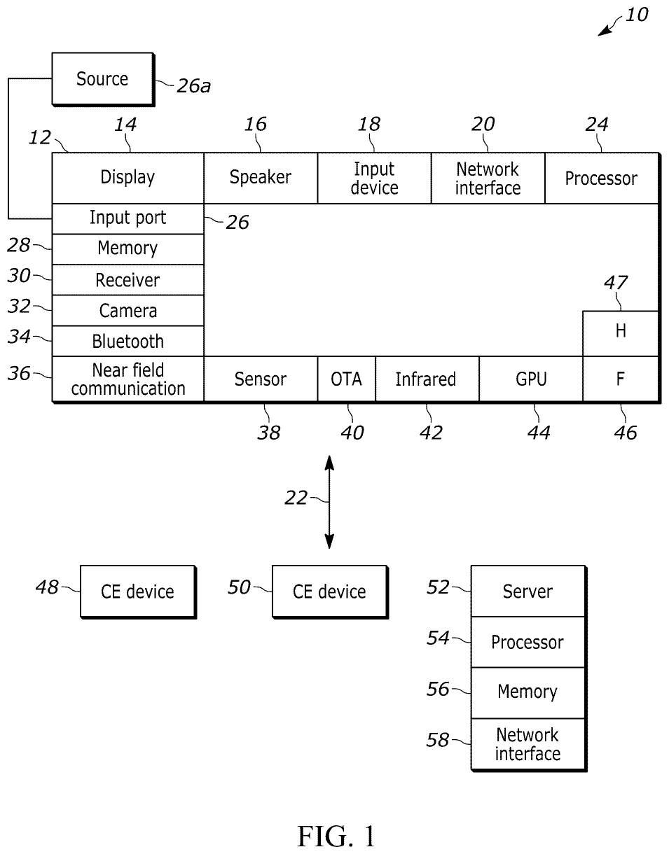

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

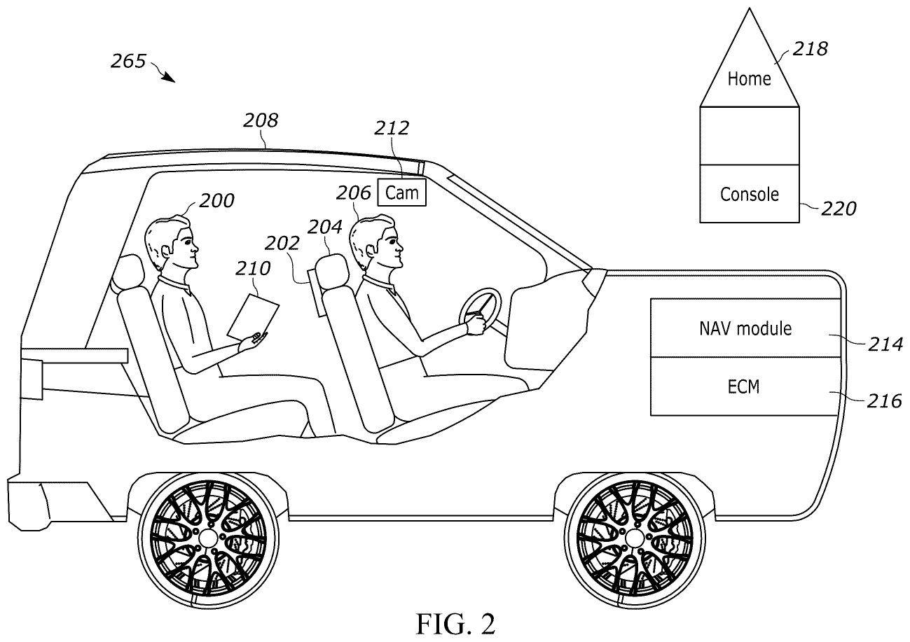

Refer now to FIG. 2. A non-driving gamer 200 can play a computer simulation such as a computer game presented on a display 202 (in the example shown, a display mounted on the seat 204 of a driver 206 of a vehicle 208) by manipulating a control device 210 such as a game controller or cell phone as the non-driving gamer is riding in the vehicle 208. Other displays may be used, e.g., cell phone display.

The vehicle 208 may be equipped with one or more RGB and/or IR cameras 212 to image the surroundings of the vehicle. The vehicle 208 further may be equipped with a navigation module 214 that stores information pertaining to the route of the vehicle 208, and an engine control module 216 that stores information pertaining to the operation of the vehicle including speed, braking, acceleration, etc. The vehicle 208 can be driven to and away from a home 218 of the gamer 200 in which the gamer can play computer simulations sourced from a game console 220 and/or from the Internet.

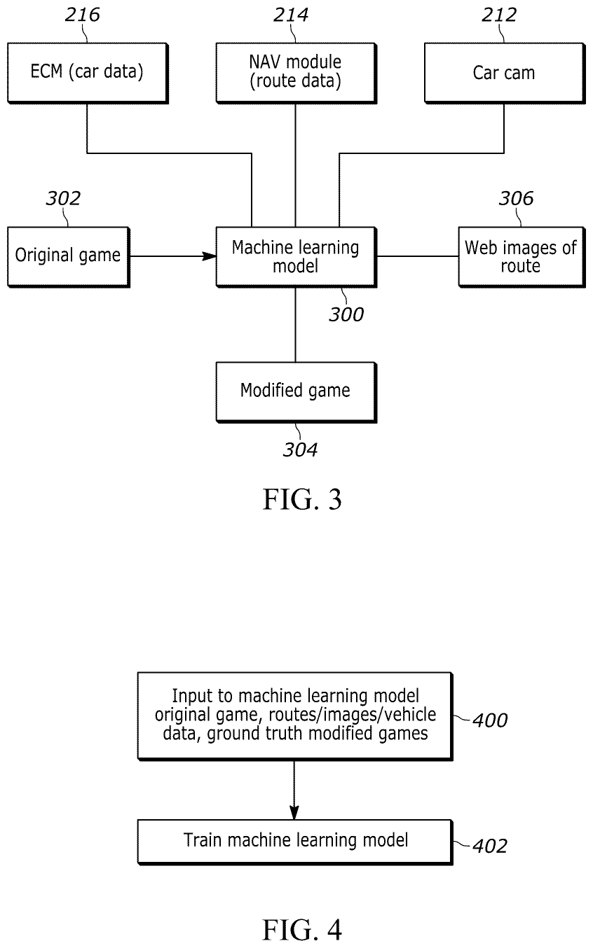

FIG. 3 provides further illustration. One or more ML models 300 may receive one or more original, unmodified computer simulations 302 such as computer games and produce one or more modified games 304 based on information from the ECM 216 shown in FIG. 2, the navigation module 214 shown in FIG. 2, the vehicle camera(s) 212 shown in FIG. 2, and images 306 from the Internet of a previous route taken by the vehicle 208. The ML model 300 may be implemented in a computer hosting the game console 220 shown in FIG. 2 with information from the components of the vehicle 208 being sent to the computer via a cell phone of the gamer or via Wi-Fi or other link afforded by the Internet. Or, the ML model 300 may be hosted in a cloud server communicating with the vehicle 208 and home computer/gaming system. Yet again, the ML model may be part of the code of a computer game or it may be native to a computer game console.

FIG. 4 illustrates example logic for training the ML model 300 shown in FIG. 3. Commencing at state 400, a training set of data is input to the ML model to train the model at state 402.

The training set of data may include one or more original computer games, multiple combinations of vehicle routes and/or route-related images, and/or ECM data, and one or more ground truth modified games of each original game corresponding to the combinations of vehicle routes and/or route-related images, and/or ECM data. Note that “vehicle route” may include walking or biking routes in which case ECM data would not be provided. The training enables the ML model to recognize terrain type, environment type, insert obstacles into a game such as buildings or fences, etc.

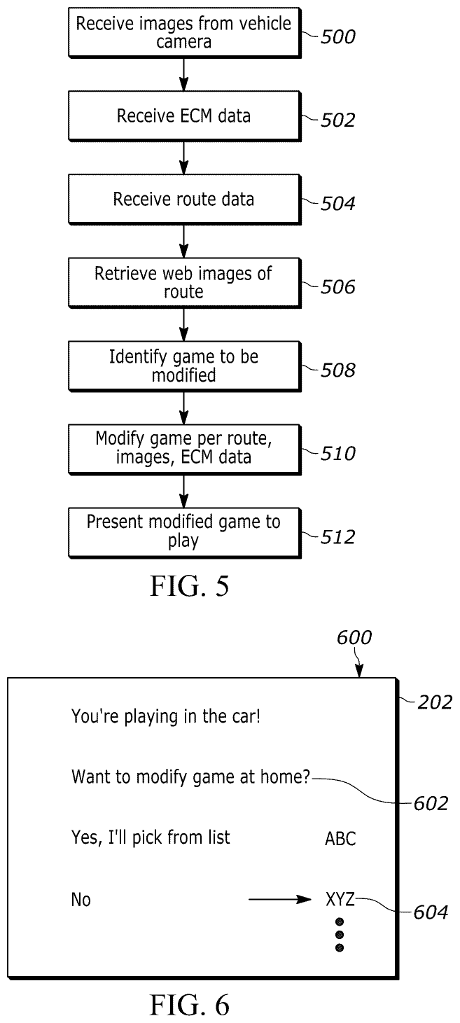

Once trained, the ML model may be used to modify an original game based on driving gaming as shown in the example of FIG. 5. Commencing at state 500, images from the vehicle camera(s) shown in FIG. 2 are received. At state 502 ECM data is received, and route data including time-based global positioning satellite (GPS) coordinates are received from the navigation module of FIG. 2. Using the route data, web-based images can be retrieved at state 506 to augment the route images from the camera shown in FIG. 2.

State 508 indicates that the original game to be modified for home play based on play in the vehicle is identified. The game is then modified at state 510 by the ML model consistent with its training using the information received at states 500, 502, 504, and 506. The game is presented as modified at state 512 for home play on the system 220 shown in FIG. 2.

Modifications to original games based on data collected during vehicle play include changing surrounding game terrain types from, e.g., city terrain to hill, beach, or forest terrain to create specific narratives and challenges in the created levels based on those environments. The ML model as trained uses the data from states 500-506 as a framework, and fills in details to add depth to environments, such as what the inside of each building would look like/contain, where enemies/obstacles are placed, etc.

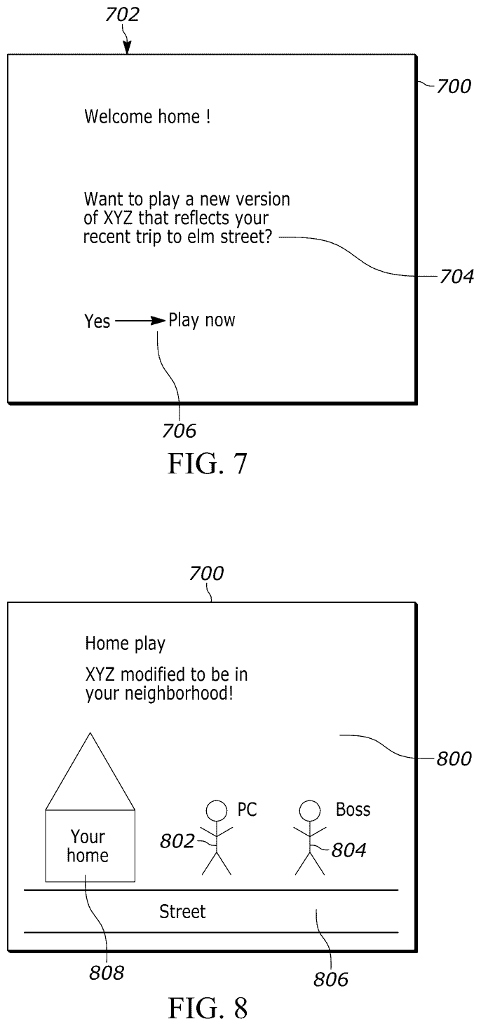

FIGS. 6 and 7 illustrate UIs consistent with disclosure above. In FIG. 6, a UI 600 presented on the display 202 of the vehicle prompting 602 the gamer to decide to modify a game for home play based on vehicle information and game play within the vehicle. The gamer may select using one or more selectors 604 which game to modify.

Subsequently, a home display 700 in FIG. 7 may present a UI 702 reflecting the gamer's selection from FIG. 6 and prompting 704 the gamer to modify a game to reflect a recent trip in the vehicle. The gamer can agree using one or more selectors 706.

FIG. 8 illustrates that a modified game 800 may be presented on the home display 700 by illustrating game characters including a player character (PC) 802 and non-player character 804 such as a “boss” to be dueling on an image of a street 806 near an image 808 of the gamer's home, with the street 806 corresponding to a route that the vehicle in FIG. 2 drove along.

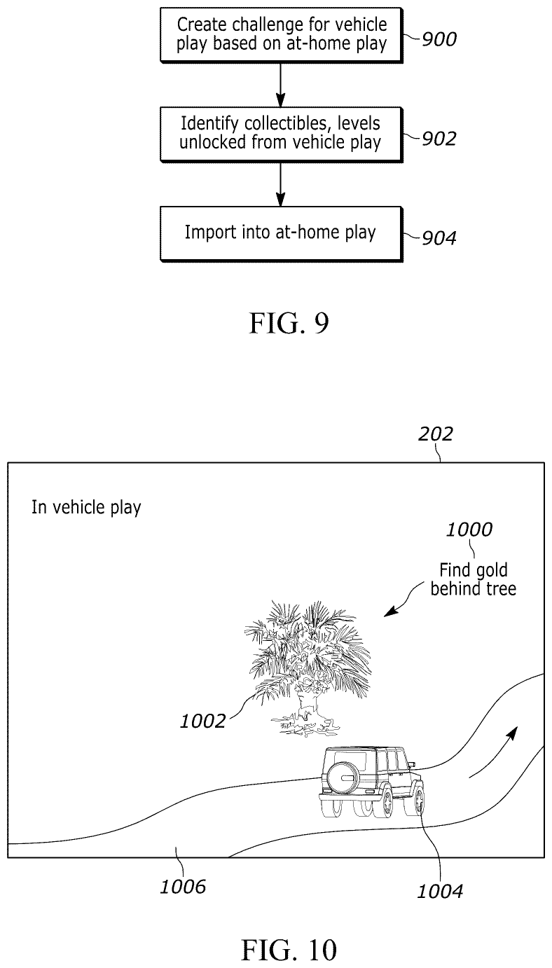

FIGS. 9-11 illustrate an additional facet of present principles to expand the home console experience that may be rules-based or ML-based. Input is received indicating the location of the home to know where home is. At state 900 the model (when ML is used) creates challenges for in-vehicle play that may be based on a history of the gamer's home play. The challenges may be leveraged at state 902 to identify game collectibles and/or unlock game levels during vehicle play to be imported at state 904 into the game during play at home. For example, meeting a challenge during vehicle play such as getting to a specific game location may unlock a weapon or other item during home play.

FIG. 10 illustrates a challenge that can be presented on the vehicle display 202 during vehicle play. A challenge is presented 1000 to locate an item (in the example shown, gold) behind a tree 1002. An image 1004 of the vehicle 208 shown in FIG. 2 may be presented as it traverses a real world road, and image 1006 of which may be presented on the display. To retrieve the gold, the gamer must navigate a game object to be located behind the tree.

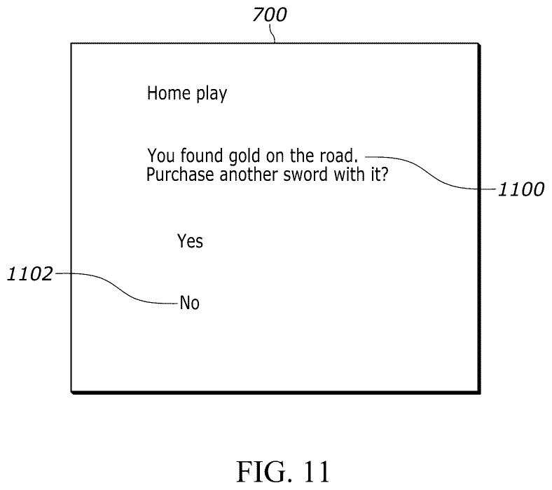

FIG. 11 illustrates that subsequently during home play the home display 700 may present a game in which a prompt 1100 is presented asking the gamer to decide whether to use the fruits of successfully meeting the in-vehicle challenge to do something during home play, in the example shown, purchase an item such as a sword using the “gold” found during vehicle play. Selectors 1102 may be used by the gamer to select whether to exploit during home play of the game the results of successfully meeting the challenge during play of the same game or another game in the vehicle.

It may now be appreciated that games can be expanded outside of the home by offering special challenges or levels that the user can do on the road (either via general distance or time based challenges, or potentially geo location specific). This allows users to obtain special items or bonus content that can be applied to their home experience (e.g., weapons, characters, maps, vehicles, attributes). If geo location specific, the user's “home base”/console is located and the local environment mapped to randomly place items in the local neighborhood or city.

Additionally, questions may be posed to users regarding their travel habits and whether they plan to take more lengthy trips in the future, and then game items can be mapped in vehicle games further beyond the immediate area of the user's home.

Location-based games may include challenges or bonuses that are unlocked depending on where the user is traveling. For example, reaching a specific city might unlock a new level or character in the game. Game developers can create special items that are only obtainable outside of the home experience and/or ones that are free to driving users and purchasable by home users. Thus, users can essentially generate levels/worlds within a given home experience based on their travel routes and environments. For example, using GPS data and on-board cameras, users ca map a given driving route to a database that auto-generates a level for them on their console at home (for applicable titles). The direct route can be used as driving levels, with GPS data/images being used to understand and map surrounding neighborhood or city areas to create surrounding “on foot” (or driving) environments. For example, the user can ride in a car driving around his block to map and auto generate a multiplayer game map that uses the user's house and surrounding buildings as a combat environment.

While the particular embodiments are herein shown and described in detail, it is to be understood that the subject matter which is encompassed by the present invention is limited only by the claims.

What is claimed is:

1. An apparatus comprising:
at least one processor system configured to:
identify route information related to a user during play of a game during travel of the user along a route; and
modify a computer simulation for play of the computer simulation at a residence related to the user based at least in part on the route information.

2. The apparatus of claim 1, wherein the computer simulation comprises a computer game.

3. The apparatus of claim 1, wherein the processor system is configured to:
identify engine control module (ECM) information generated during the travel of the user along the route; and
modify the computer simulation based at least in part on the ECM information.

4. The apparatus of claim 1, wherein the processor system is configured to:
identify one or more images generated by a camera during the travel of the user along the route; and
modify the computer simulation based at least in part on the one or more images.

5. The apparatus of claim 1, wherein the processor system is configured to:
identify one or more images related to the route from an Internet source; and
modify the computer simulation based at least in part on the one or more images related to the route from an Internet source.

6. The apparatus of claim 1, wherein the processor system is configured to:
present, in a computer game being played by a user as the user travels along the route, at least one challenge;
responsive to the user meeting the challenge, unlock a collectible and/or level in the computer simulation during play of the computer simulation at a residence related to the user.

7. The apparatus of claim 6, wherein the processor system is configured to:
responsive to the user meeting the challenge, unlock a collectible in the computer simulation during play of the computer simulation at a residence related to the user.

8. The apparatus of claim 6, wherein the processor system is configured to:
responsive to the user meeting the challenge, unlock a level in the computer simulation during play of the computer simulation at a residence related to the user.

9. A device comprising:
computer memory that is not a transitory signal and that comprises instructions executable by at least one processor system to:
present, in a computer game being played by a user as the user travels along a route, at least one challenge;
responsive to the user meeting the challenge, unlock a collectible and/or level in a computer simulation during play of the computer simulation at a residence related to the user.

10. The device of claim 9, wherein the instructions are executable to:
responsive to the user meeting the challenge, unlock a collectible in the computer simulation during play of the computer simulation at a residence related to the user.

11. The device of claim 9, wherein the instructions are executable to:
responsive to the user meeting the challenge, unlock a level in the computer simulation during play of the computer simulation at a residence related to the user.

12. The device of claim 9, wherein the instructions are executable to:
identify route information related to the user during play of the computer game during travel of the user along the route; and
modify the computer simulation for play of the computer simulation at the residence related to the user based at least in part on the route information.

13. The device of claim 9, wherein the computer simulation comprises a computer game.

14. The device of claim 9, wherein the instructions are executable to:
identify engine control module (ECM) information generated during the travel of the user along the route; and
modify the computer simulation based at least in part on the ECM information.

15. The device of claim 9, wherein the instructions are executable to:
identify one or more images generated by a camera during the travel of the user along the route; and
modify the computer simulation based at least in part on the one or more images.

16. The device of claim 9, wherein the instructions are executable to:
identify one or more images related to the route from an Internet source; and
modify the computer simulation based at least in part on the one or more images related to the route from an Internet source.

17. A method comprising:
presenting a computer simulation on a display in a vehicle as the vehicle travels along a route;
tying play of the computer simulation in the vehicle to at-home game experiences by using travel data and/or captured images during travel and/or web-based knowledge to generate similar environments for an at-home game.

18. The method of claim 17, comprising using vehicle data and routes to map an environment which is imported into an at-home game using machine learning.

19. The method of claim 17, comprising:
expanding home console experience by knowing where home is and creating challenges, collectibles, and unlocking levels based on in-vehicle play.
